(19) United States
(12) Patent Application Publication
(10) Pub. No.: US 2008/0144004 A1
(43) Pub. Date: Jun. 19, 2008

(54) Optical Spectrophotometer

(75) Inventor: Robert D. Rosenthal, Silver Spring, MD (US)

Correspondence Address: ROTHWELL, FIGG, ERNST & MANBECK, P.C., 1425 K STREET, N.W., SUITE 800, WASHINGTON, DC, 20005, US

(73) Assignee: Futrex Inc., Gaithersburg, MD (US)

(21) Appl. No.: 11/956,828

(22) Filed: Dec. 14, 2007

Related U.S. Application Data
(60) Provisional application No. 60/874,966, filed on Dec. 15, 2006.

(51) Int. Cl. G01N 21/25

(52) U.S. Cl. 356/39

(57) ABSTRACT

In one aspect, the present invention provides systems and methods for non-invasively determining the amount of an analyte in a subject's blood using a set of light sources and a set of light detectors for measuring optical density. Advantageously, in embodiments of the invention, the light sources are operated such that each of the light sources outputs light at the same time, thereby concurrently illuminating the fingertip with light from each light source, and while the fingertip is illuminated by the light sources, a data processor reads data output from each light detector substantially simultaneously.

This application claims the benefit of U.S. Provisional Patent Application No. 60/874,966, filed on Dec. 15, 2006, the entire disclosure of which is incorporated herein by reference.

### BACKGROUND

The use of visible and near-infrared quantitative spectroscopy has been widely accepted in the agricultural, industrial and medical fields. This technology is now used in such varied applications as measuring protein/oil/moisture in grains, measuring percent body fat in humans, and measuring composition of pharmaceutical products.

In most of these near-infrared quantitative light transmission measurements, it is important to use high optical energies and sensitive detectors to allow measurements to be made through objects that are normally thought of as being near opaque or opaque. For example, light transmission measurements are now commonly made through apples to determine their maturity and consumer acceptability or transmitted through many centimeters of grain and oilseeds to determine their nutritional properties.

Near-infrared (and visible) quantitative analysis systems incorporate optical systems that provide light transmission measurement at a number of sequentially illuminated wavelengths (e.g., wavelengths 1 though wavelength n). In such systems, wavelength 1 is turned on and detector's energy level is measured (i.e., the amount of light passing through the subject is measured). Then wavelength 1 is no longer illuminated, wavelength 2 is turned on, and a second light transmission measurement is made. This process is sequentially repeated until the light transmission for all wavelengths is measured.

For example, in a spinning wheel approach (see FIG. 1), optical filters are placed in a wheel and as the wheel turns under the light source, that optical filter transmits light to the object being measured and a detector then provides an electrical signal representative of the light transmission for that wavelength of light. In this approach the speed at which the wheel rotates determines how fast the total number of wavelengths are measured.

A second approach that has been used in the past is the use of light emitting diodes (LEDs) or infrared emitting diodes (IREDs), where no moving parts are involved (see FIG. 2). In this approach, as taught in U.S. Pat. No. 4,286,327, the first IRED is illuminated and a light transmission measurement is made. Then that IRED is shut off, the next IRED is illuminated, and a second measurement is obtained. This sequential measurement is continued until all wavelengths have been measured at least once. In this approach, the wavelength sensitivity can be improved by placing narrow band optical filters in front of the various IREDS.

Another approach is to use a more complex and expensive system such as a grating or a prism. By rotating them in a light beam generates a sequential spectrum. Such measurements can be made at a rate perhaps as high as ten spectrum scans each second.

The above approaches have proven to be extremely robust and valuable in measurement of non-changing products such as grains/oilseeds, and laboratory chemicals. However, they do not allow meaningful measurements where the object being measured is changing fairly rapidly with time. For example, if multi-wavelength measurement is desired through a person's fingertip to measure blood analytes during a single heart beat or multiple heart beats, the previously described sequential wavelength approaches introduce significant measurement errors.

FIG. 3a illustrates a typical person's pulse wave determined by doing a light transmission measurement. If we assume that the person's heart rate is sixty beats per minute, then the time between the start of any pulse beat and the end, as shown as distance RR in FIG. 3a, is one second. Since the speed of a typical high-speed sequential measurement optical system is ten measurements per second, the various wavelengths provide measurements at different places on the pulse curve. This can introduce a large error as illustrated in FIG. 3b (same data as FIG. 3a except vertical scale is enlarged).

### SUMMARY

What is needed is a low-cost means of simultaneously measuring multiple wavelengths with enough energy so that measurements can be made through objects that may have high optical densities (ODs). This patent discloses systems and methods for performing such simultaneous multiple wavelength measurements.

Accordingly, in one aspect, the present invention provides a system for determining the amount of an analyte in a subject's blood. In some embodiments, the system includes: a set of light sources; a set of light detectors, each light detector being operable to output data corresponding to an amount of light reaching the light detector; a set of filters, each filter being positioned in front of one of the light detectors; a data processor, the data processor being coupled to each light detector and being operable to read the output of each light detector. The light sources are configured such that when the system is in operation the light sources simultaneously emit light, the data processor is configured to read the data output from each light detector at substantially the same time (i.e., at the same time or within some non-significant amount time) when the system is in operation, and the data processor is further configured to use the read data to calculate the amount of the analyte.

In another aspect, the invention provides a method for determining the amount of an analyte in a subject's blood. In some embodiments, the method includes the steps of: (1) obtaining a device comprising: (i) a set of light sources and (ii) a set of light detectors, each light detector being operable to output data corresponding to an amount of light reaching the light detector; (2) positioning the device and/or a finger of the subject such that the fingertip of the finger is positioned between the set of light sources and the set of detectors; (3) operating the light sources such that each of the light sources outputs light at the same time, thereby concurrently illuminating the fingertip with light from each light source; (4) while performing step (3), using a data processor to read data output from each light detector substantially simultaneously (i.e., at the same time or within some non-significant amount time); and (5) after performing step (4), using the data to calculate the amount of the analyte.

The above and other aspects and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements.

FIG. 1 illustrates a prior art multiple wavelength apparatus.

FIG. 2 illustrates a prior art multiple wavelength apparatus.

FIGS. 3a-3b illustrate a typical person's pulse wave determined by doing a light transmission measurement.

FIG. 4 illustrates an apparatus according to an embodiment of the invention.

FIG. 5 is a schematic of a circuit according to an embodiment of the invention.

FIGS. 6a-b are plots of detector energy versus time.

FIG. 7 illustrates noise spikes.

FIG. 8 illustrates the total signal obtained by shining light through the finger at a single wavelength.

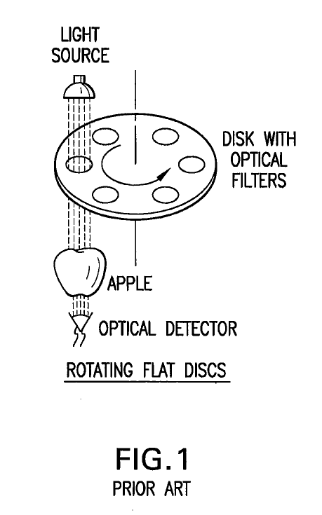

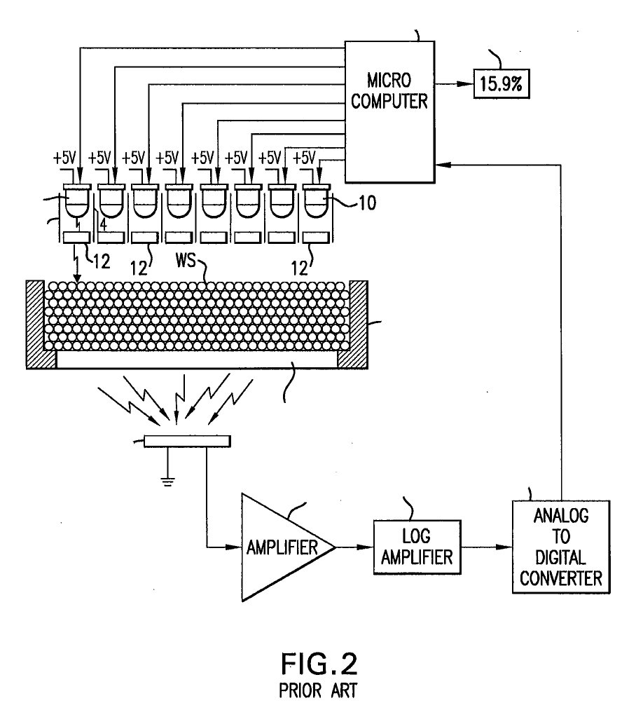

### DETAILED DESCRIPTION OF PREFERRED EMBODIMENTS

As used herein, the words “a” and “an” mean “one or more.”

As previously described, we have determined that it is advantageous to provide simultaneous optical measurements at multiple wavelengths. This is analogous to when you take a photograph. Every item within the photograph is positioned relative to each other at the same instant in time. The same is desired to be true for measurements at multiple number of wavelengths required for quantitative near-infrared measurement of dynamically changing sample (e.g. a fingertip light transmission measurement during a pulse beat).

Typical near-infrared quantitative instruments require measurements at many wavelengths (e.g., a minimum between ten and sixteen wavelengths) in order to be successful. For the sake of discussion, we will assume the number required to provide a meaningful measurement of a blood analyte (e.g., glucose, cholesterol, etc.) is fourteen wavelengths. One inexpensive way to accomplish this is using the LED/IRED approach described in the previously referenced patent. In that patent, the fourteen wavelengths are generated by fourteen separate IREDS. Placed in front of each IRED is a narrow bandpass optical filter that only allows a specific wavelength to illuminate the sample. As the light penetrates through the sample or reflects off the sample, a single detector measures the amount of light that passed through the sample. As previously described, the prior approach allows the light transmission detection of all the wavelengths occur sequentially, rather than simultaneously. The first IRED is illuminated while all the others are in the “off” state. The detector signal is measured and then the first IRED is turned off. A second IRED is then illuminated. The same detector then measures the light captured for the second IRED. This sequence is continued until all the IREDs have been sequentially illuminated and their signals measured. In actual use, this sequential illumination is performed many times on the sample, thereby, allowing a noise averaging for each individual wavelength.

### The “Snapshot Approach” Embodiment

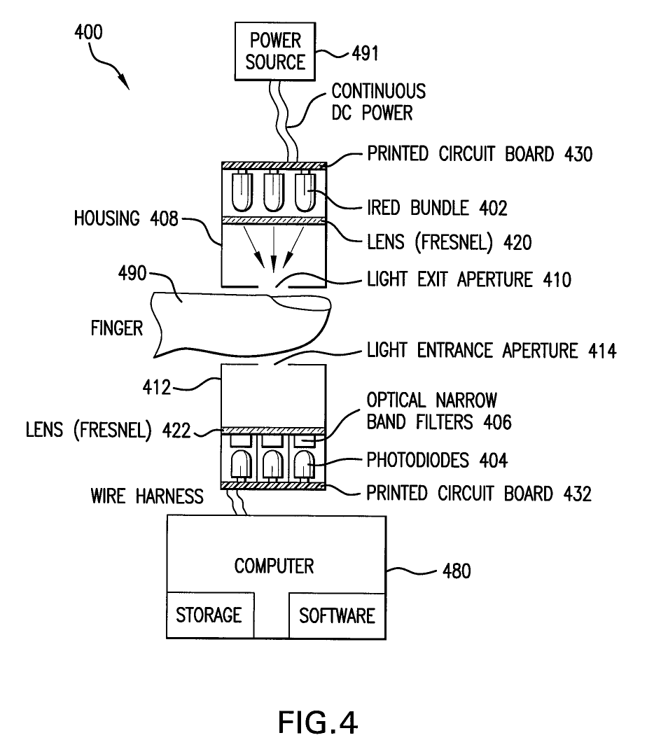

Referring now to FIG. 4, FIG. 4 illustrates a system 400, according to an embodiment of the invention, for providing simultaneous or substantially simultaneous measurement of multiple wavelengths. This embodiment is referred to as the “snapshot approach.”

As illustrated in FIG. 4, system 400 includes a set of light sources 402 (e.g., a set of infrared emitting diodes (IRED)), which may be connected to a circuit board 430 for delivering power to the light sources 402; a set of light detectors 404; and a set of narrow bandpass filters 406, each of which is configured to allow a different wavelength to pass through the filter.

The set of light sources 402 (a.k.a., “light bundle 402”) may include a number of different IREDs so that illumination is available throughout a spectrum range of interest. For example, a typical light bundle 402 could include an IRED outputting a wavelength in the 850-905 nanometer (nm) range (e.g., Marubani America Corp., Part L890-01AU), an IRED outputting a wavelength in the 910-920 nm range (e.g., IBID, Part L910-01), an IRED outputting a wavelength in the 935-955 nm range (e.g., IBID, Part L940-01AU), an IRED outputting a wavelength in the 965-980 nm range (e.g., IBID, Part L970-01), and an IRED outputting a wavelength in the 1020-1060 nm range (e.g., IBID, Part L1050-01). Such a light bundle allows measurement from approximately 850 nm through 1060 nm.

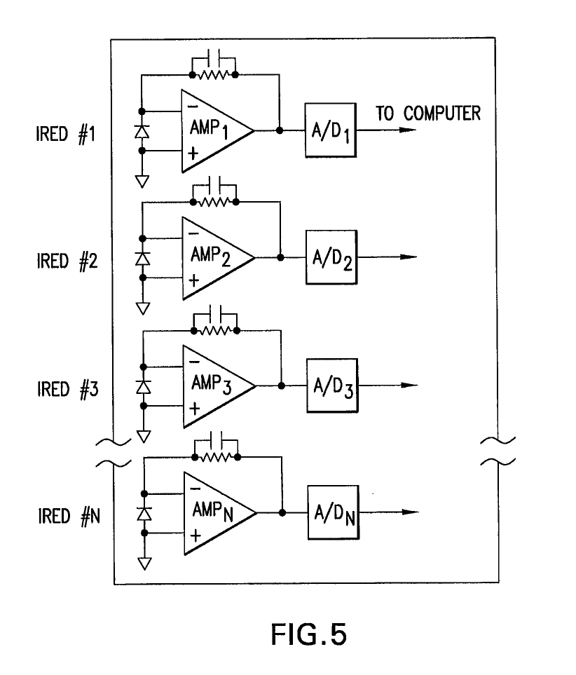

In some embodiments, each of the detectors 404 is small in size so that light can be captured from a small area; e.g., from the pad area of a small finger. In some embodiments, near-infrared photodiodes may be employed (e.g., Perkin-Elmer Model VTD34H). Preferably, each detector 404 includes a photodetector, amplifying circuitry and an analog-to-digital (A/D) converter. This feature is illustrated in FIG. 5, which shows an example detector 404 that includes: a photodiode 500 coupled to an amplifier 502, the output of which is coupled to input of an A/D converter 504. By using such detectors, all wavelengths measurement can made simultaneously without any significant lag time between the first to the last measurement. These detectors allow measurements between approximately 360 nm to 1100 nm.

An alternate detector using a conventional InGas photodiode allows measurement further into the near-IR, from 900 to 1700 nm. In this spectrum region, there are commercially available IREDs and thus the Snapshot Approach is applicable. It is also possible to purchase enhanced InGas photodiodes that operate up to 2,600 nm. However, there are no practical IRED's that operate at these larger wavelengths.

To provide the distinct multiple wavelengths to be measured (e.g, fourteen wavelengths) each filter 406 may be positioned in front of one of the detectors 404, as illustrated in FIG. 4.

As further illustrated, light bundle 402 may be housed in or positioned adjacent to the rear of a housing 408. Housing 408 may include a light exit aperture 410 at one end thereof to allow light from the light bundle to exit housing 408 and impinge on the test object 490. Similarly, detectors 404 and filters 406 may be housed in or positioned adjacent to the rear of a housing 412. Housing 412 may include a light entrance aperture 414 at one end thereof to allow light that passed through the subject 490 to enter the housing and then impinge on a detector 404 after having passed through a filter 406 positioned in front of the detector 404.

During use of system 400, housing 408 and housing 412 may be aligned such (a) light exit aperture 410 faces light entrance aperture 414 and (b) there is a space between the light exit aperture 410 and the light entrance aperture 414 for receiving a test object. In embodiments where the test object is a person's finger 490, the width of the space is about the width of a finger (e.g., between about ⅛ of an inch and 2 inches, more preferably between about ¼ of an inch and 1 inch).

As further illustrated, there are no optical filters between the light sources and the test object 490, but there may be one or more lenses (e.g., Fresnel lenses positioned between light bundle 402 and the subject 490). Additionally, light bundle 402 may be connected to a power source 491 (e.g., a source of DC power) and each detector 404 may be interfaced to a data processing system 480 (e.g., a processing system including one or more conventional computers) that may be configured to obtain data output from each detector 404, store the data in a storage device 441 (e.g., disk drive), and store and execute software 442 for analyzing the stored data.

In some embodiments, each light source in the bundle 402 may be left on continually. Thus, the light bundle is similar to the way a typical light bulb is continually left on in a conventional spectrometer.

When system 400 is used to measure a blood analyte for a patient, the patient may insert his/her finger in the space between housings 408 and 412. Once the finger is in place, the light bundle 402 may be turned on if it is not already one. After the light bundle 402 is turned on, data processing system 480 can begin collecting data from each detector 404. Preferably, this data collection is done in parallel. That is, processing system 480 reads the output of each detector at the same time. Processing system 480 may be configured to performing this parallel reading step periodically for at least a minimum amount of time (e.g., 20 seconds), thereby producing a time-based set light transmission measurements for each wavelength.

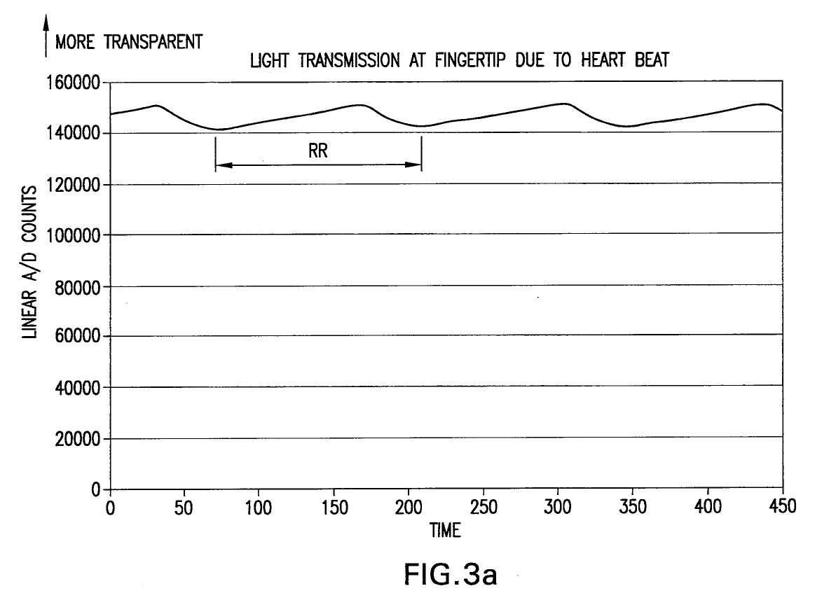

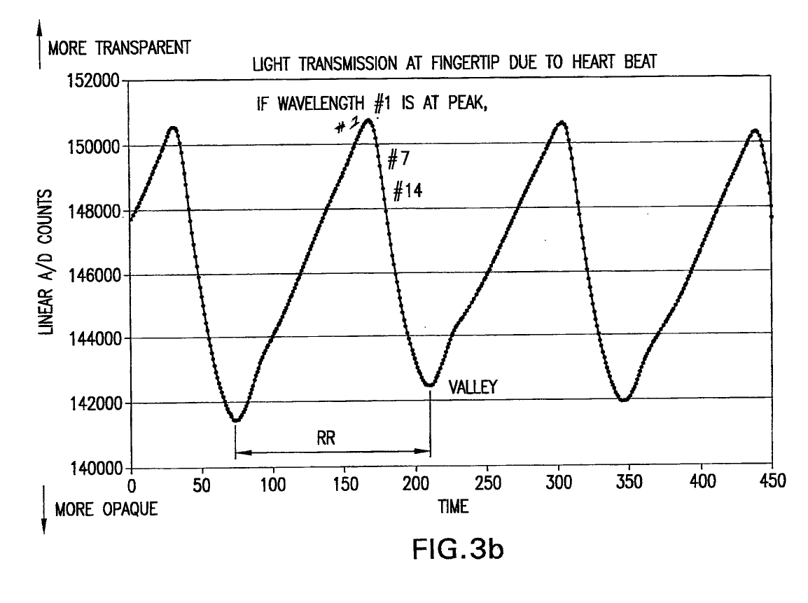

The data plot in FIG. 3B represents such a set of data for one particular wavelength. Once a sufficient amount of data has been collected, processing system 480 may process the data to determine a value or values corresponding to a concentration of one or more blood analytes. The procedure for processing the data is described further below.

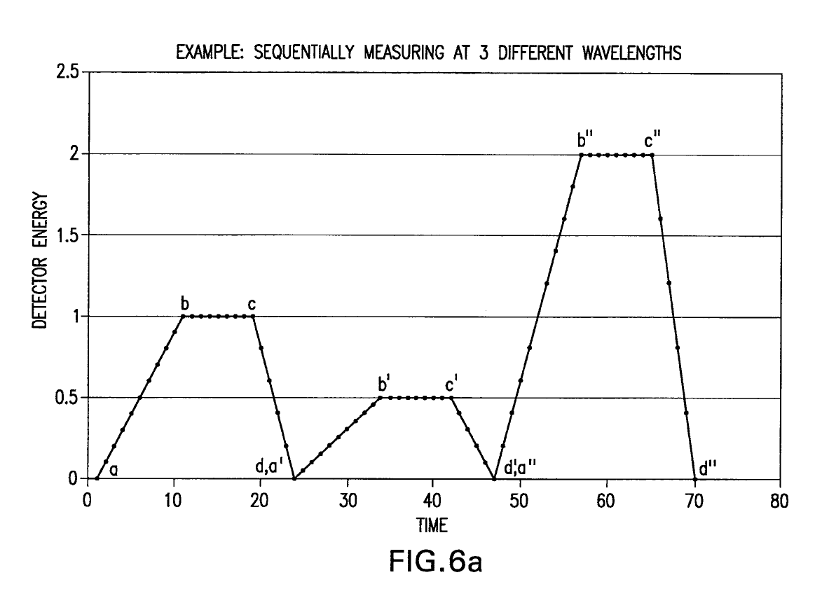

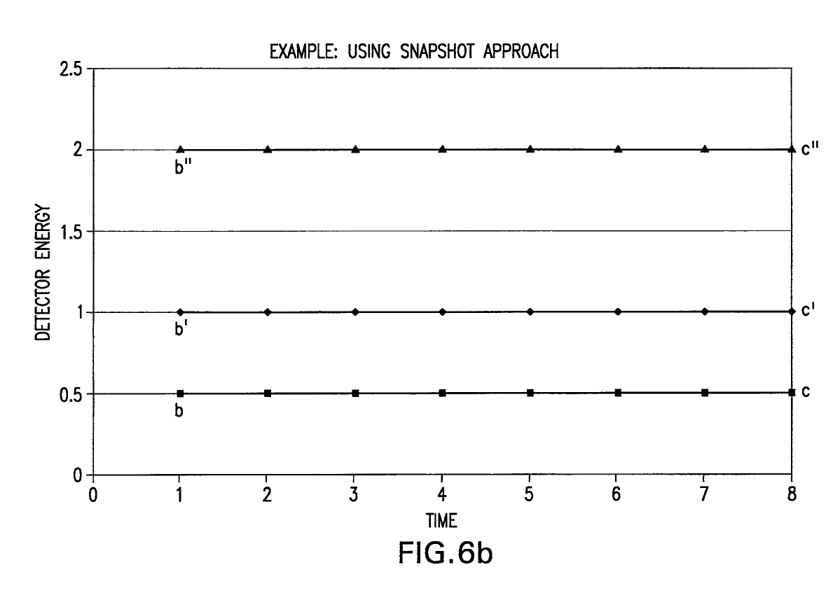

In addition to eliminating measurement error due to sequential measurement of dynamic samples, the snapshot approach also has another advantage; it eliminates the significant wasted time inherent in sequential measurements. As illustrated in FIG. 6a, each sequential wavelength is composed of three time durations: Time from “a” to “b” is the warmup time for the IRED where no measurements can be made; time from “b” to “c” is the stable time period where measurements can be performed; time from “c” to “d” is the turn off time of the IRED during which no measurements can be made. (Note: For pictorial simplicity, FIG. 6a only shows measurement at three wavelengths.)

As illustrated in FIG. 6b, the snapshot approach eliminates all the waste times that is inherent in the sequential filter approach. This feature thus allows considerably more analog to digital (A/D) conversions to be made during the former approaches wasted time. Since random noise is reduced by the square root of the number of A/D conversions, the Snapshot Approach allows more precise measurements.

### Virtual Cuvette

If non-invasive blood measurement is desired at any place on the human body, light must penetrate through the skin as well as various tissue, interstitial fluid, venous and arterial blood. Fingertip measurement is usually preferred because this is the point where there is a large concentration of capillaries where the arterial blood converts into venous blood. As illustrated in FIG. 3a, the light absorption of arterial blood in the capillary due to the heart beat is very small compared to the light absorption of the tissues and other constituents. This figure illustrates the total signal obtained by shining light through the finger at a single wavelength. You will note that the cyclic pattern of the pulse is quite small in relationship to the total absorption scale. This fact causes major problems in obtaining meaningful non-invasive quantitative measurement of blood analytes (e.g., blood glucose).

However, in studying FIG. 3b it is clear that in the cyclic pattern itself, there is considerable information. For example, if the vertical scale is the amount of light captured by a detector 404 after light is transmitted through the finger, the “peak” reading of the cyclic pattern occurs when the minimum amount of blood is in the capillaries. The “valley” reading is when the most blood is in the capillaries. This fact allows the concept of using a Virtual Cuvette to perform the analysis.

The Virtual Cuvette only uses optical information provided at the peak of the cyclic wave and at the valley of the cyclic wave. Since only one peak and one valley occurs during each heartbeat, a statistically significant number of heartbeats are used in order to average out Gaussian noise sources.

The major advantage of using the Virtual Cuvette is that it eliminates the major constituents that are in the finger that are not in the capillaries; e.g., fat, muscle (i.e., protein), and water are excluded. Moreover, the interstitial fluid and non-capillary venous and arterial blood are also excluded. Thus, the only thing being measured is the blood in the capillaries thereby eliminating the source of major interferences for deriving blood analyte calibrations suitable for use by the general public.

Accordingly, using the Virtual Cuvette approach, processing system 480 determines an optical density (OD) value for each wavelength i, using the following Equation (Equation 1):

$${OD}_{i} = \frac{\sum [ \begin{matrix}( Log 1 / {T}_{p = 1} - Log 1 / {T}_{v = 1} ) + \\ ( Log 1 / {T}_{p = 2} - Log 1 / {T}_{v = 2} ) … ( Log 1 / {T}_{p = n} - Log 1 / {T}_{v = n} )\end{matrix} ]}{n}$$

Where: ODᵢ is the effective Log 1/T of the Virtual Cuvette; n is the number of pulse beats being averaged; Tₚᵢ is a value representing the amount of light transmitted through the body part at the peak of the i^{th} pulse beat (e.g., Tₚ₁ is a value representing the amount of light transmitted through the body part at the peak of the first pulse beat and Tₚ₂ is a value representing the amount of light transmitted through the body part at the peak of the second pulse beat); and Tᵥᵢ is a value representing the amount of light transmitted through the body part at the valley of the i^{th} pulse beat (e.g., Tᵥ₁ is a value representing the amount of light transmitted through the body part at the valley of the first pulse beat). The value Tₚᵢ or Tᵥᵢ may be determined by taking a value output by the A/D converter 504 and dividing that value by 2ⁿ−1, where n is the number of bits output by the A/D converter. For example, if the A/D converter is a 16 bit A/D converter, then T may be determined by taking the value output by the converter and dividing that number by 2¹⁶−1.

### Median Filtering

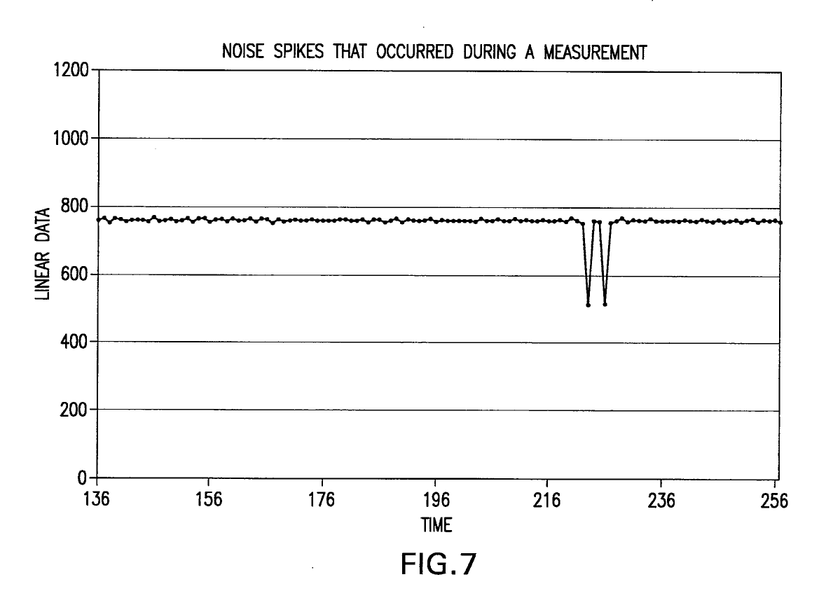

A “median” is the midpoint of a set of numbers; that is, half the numbers have values that are greater than the median and half have values that are less. “Median Filtering” is using the median concept to remove “noise spikes” from a set of numbers. For example, FIG. 7 is the actual A/D data for 128 separate peak measurements. Typically, in near-infrared quantitative analysis, these results are averaged to obtain the actual result to be used in either calibration or prediction of unknowns. Such averaging is valid if the distribution of errors is Gaussian provided there is a reasonably large number of readings.

However, in some near-infrared applications, errors occur that are not Gaussian. These “noise spikes” could be due to faults in the electronics or artifacts due to motion of the object being measured. If the average of all 128 values in FIG. 7 is used, the resultant value would be incorrect because you have averaged in large errors that have no meaning towards the measurement.

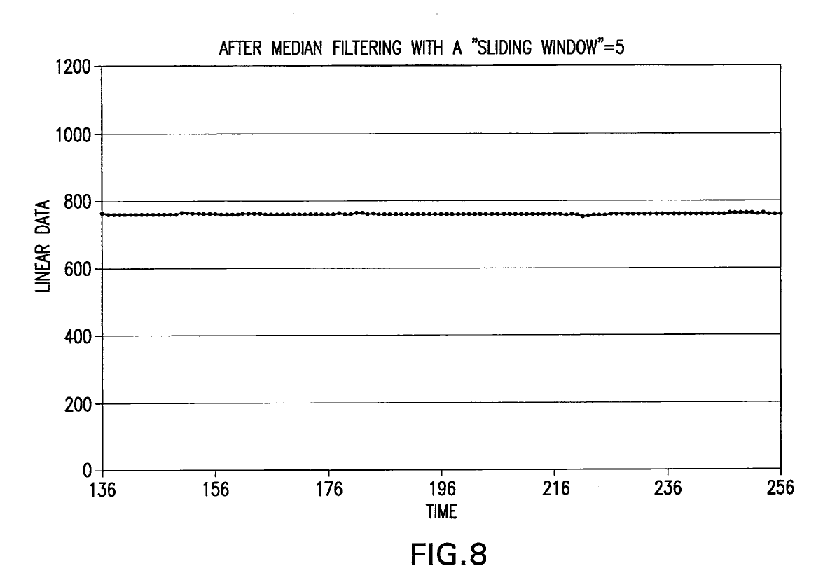

Use of Median Filtering has been proven to be of great value to eliminate such noise spikes. In this approach, a “sliding window” is used that moves through all the data. For example, for the data in FIG. 7, FIG. 8 shows the results of using a sliding window value of 5. Saying this differently, it looks at the first five values and selects the median value as the first number. The second number is the median of scans 2 through 6, third number of scans 3 through 7, etc. As shown in FIG. 8, this approach effectively eliminates these outlier noise spikes.

A search of the technical literature of near-infrared quantitative analysis didn't reveal any prior use of Median Filtering on the raw data obtained. The use of Median Filtering has two distinct advantages compared to other techniques such as smoothing. First, it in no way eliminates meaningful data by averaging in bad data, thereby reducing the potential accuracy. In fact, it improves the potential accuracy. Second, it definitely improves the precision of measurement.

### Different “Thickness” of Virtual Cuvettes

The effective thickness of the previously described Virtual Cuvette varies considerably from person to person. Some people might have Virtual Cuvettes that are five to ten times “thicker” than other people. This variation in effective thickness can cause significant loss of accuracy when attempting to provide a single calibration suitable to the general population for quantitative measurement of blood analytes such as blood glucose, cholesterol and hemoglobin.

This thickness variability of the Virtual Cuvette can be eliminated by using the following equation: OD_{icor}=ODᵢ/(A/B) (Equation 2), where: “OD_{icor}” is the corrected value to be used in the calibration equation; “ODi” is defined above (see Equation 1); “A” is the sum of all ODs measured in a particular sample (e.g. one person); and “B” is the average of all ODs measured on all samples during the calibration of the instrument.

In this equation the numerator is Log 1/T value for each of the fourteen wavelengths. The denominator is the sum of all the Log 1/T terms measured for a particular sample divided by the average of the number of Log 1/T terms for all samples used in the calibrations. By such normalization, the difference between samples (e.g. individuals) are essentially eliminated, and therefore, a general calibration suitable for measurement of the entire population becomes feasible.

This same normalization technique also improves both precision and accuracy in a broad range of other Near-IR measurements. Such applications include: Eliminating the loss of accuracy when measuring the constituents in whole grain due to “bridging” of the grain particles; Improving accuracy and precision of NIR measurement of gasoline octane number when measured in commercial-grade jars that have varying wall thickness.

Once the data processing system 480 has the corrected OD values, the processing system 480 can determine the amount of a blood analyte for the subject by using, for example, an equation of the form: a*OD_{1cor}+b*OD_{2cor}+ . . . +n*OD_{ncor}+C (Equation 3), where a, b, . . . , n and C are constants that have been determined experimentally.

### Calibration Approaches

One benefit of all the preceding described advancements is that it does not affect the method of calibrating a near-infrared quantitative instrument. The calibration procedure whether it is Multiple-Linear Regression (“MLR”) or Partial Least Squares (“PLS”) or other techniques remain identical.

While various embodiments/variations of the present invention have been described above, it should be understood that they have been presented by way of example only, and not limitation. Thus, the breadth and scope of the present invention should not be limited by any of the above-described exemplary embodiments. Further, unless stated, none of the above embodiments are mutually exclusive. Thus, the present invention may include any combinations and/or integrations of the features of the various embodiments.

Additionally, while the processes described above and illustrated in the drawings are shown as a sequence of steps, this was done solely for the sake of illustration. Accordingly, it is contemplated that some steps may be added, some steps may be omitted, and the order of the steps may be re-arranged.

What is claimed is:

1. A system for determining the amount of an analyte in a subject's blood, the system comprising:
a set of light sources;
a set of light detectors, each light detector being operable to output data corresponding to an amount of light reaching the light detector;
a set of filters, each filter being positioned in front of one of the light detectors;
a data processor, the data processor being coupled to each light detector and being operable to read the output of each light detector, wherein
the light sources are configured such that when the system is in operation the light sources simultaneously emit light;
the data processor is configured to read the data output from each light detector at substantially the same time when the system is in operation; and
the data processor is further configured to use the read data to calculate the amount of the analyte.

2. The system of claim 1, wherein the filters are configured such that, when the system is in operation, the light reaching a light detector must first pass through the subject and then one of the filters prior to reaching the light detector.

3. The system of claim 1, wherein the set of light sources comprises at least two light sources.

4. The system of claim 3, wherein each light source in the set of light sources is configured to output a different wavelength of light.

5. The system of claim 4, wherein one of the light sources in the set is an infrared emitting diode configured to output light having a wavelength in the 850-905 nm range, and another of the light sources in the set is an infrared emitting diode configured to output light having a wavelength in the 910-920 nm range, the 935-955 nm range, the 965-980 nm range, or the 1020-1060 nm range.

6. The system of claim 1, wherein the data processor is further configured to calculate an optical density value corresponding to each wavelength used by the system.

7. The system of claim 6, wherein the data processor is configured to use Equation 1 to calculate the optical density values.

8. The system of claim 7, wherein the data processor is further configured to use Equation 2 to calculate corrected optical density values.

9. The system of claim 8, wherein the data processor is further configured to use the corrected optical density values in determining the amount of the analyte.

10. The system of claim 1, further comprising:
a first housing that houses the a set of light sources, the first housing having a light exit aperture for allowing light emitted from the light sources to exit the first housing; and
a second housing that houses the set of light detectors and the set of filters, the second housing having a light entrance aperture for allowing light to enter the second housing, wherein the filters and light detectors are arranged such that light entering the second housing though the light entrance aperture passes though one of the filters prior to reaching the detector that is positioned behind the filter, wherein
the first housing and the second housing are arranged such that the light entrance aperture and the light exit aperture are facing each other and separated by a space that is between about ⅛ of an inch and 2.0 inches wide.

11. A method for determining the amount of an analyte in a subject's blood, the system comprising:
(1) obtaining a device comprising: (i) a set of light sources and (ii) a set of light detectors, each light detector being operable to output data corresponding to an amount of light reaching the light detector;
(2) positioning the device and/or a finger of the subject such that the fingertip of the finger is positioned between the set of light sources and the set of detectors;
(3) operating the light sources such that each of the light sources outputs light at the same time, thereby concurrently illuminating the fingertip with light from each light source;
(4) while performing step (3), using a data processor to read data output from each light detector substantially simultaneously; and
(5) after performing step (4), using said data to calculate the amount of the analyte.

12. The method of claim 11, wherein the device further comprises a set of filters, the filters being configured such that the light reaching a light detector must first pass through the subject and then one of the filters prior to reaching the light detector.

13. The method of claim 11, wherein the set of light sources comprises at least two light sources.

14. The method of claim 13, wherein each light source in the set of light sources is configured to output a different wavelength of light.

15. The method of claim 14, wherein one of the light sources in the set is an infrared emitting diode configured to output light having a wavelength in the 850-905 nm range, and another of the light sources in the set is an infrared emitting diode configured to output light having a wavelength in the 910-920 nm range, the 935-955 nm range, the 965-980 nm range, or the 1020-1060 nm range.

16. The method of claim 11, further comprising calculating an optical density value corresponding to each wavelength used by the device.

17. The method of claim 16, further comprising using Equation 1 to calculate the optical density values.

18. The method of claim 17, further comprising using Equation 2 to calculate corrected optical density values.

19. The method of claim 18, further comprising using the corrected optical density values in determining the amount of the analyte.

20. The method of claim 11, wherein the device further comprises:
a first housing that houses the a set of light sources, the first housing having a light exit aperture for allowing light emitted from the light sources to exit the first housing; and
a second housing that houses the set of light detectors and a set of filters, the second housing having a light entrance aperture for allowing light to enter the second housing, wherein the filters and light detectors are arranged such that light entering the second housing though the light entrance aperture passes though one of the filters prior to reaching the detector that is positioned behind the filter, wherein
the first housing and the second housing are arranged such that the light entrance aperture and the light exit aperture are facing each other and separated by a space that is between about ⅛ of an inch and 2.0 inches wide.
